(19) United States
(12) Patent Application Publication
(10) Pub. No.: US 2014/0121302 A1
(43) Pub. Date: May 1, 2014

(54) Cementitious Material for Cold Weather Applications

(71) Applicant: Joshua V. Brien, Lexington, KY (US)

(72) Inventor: Joshua V. Brien, Lexington, KY (US)

(21) Appl. No.: 13/803,316

(22) Filed: Mar. 14, 2013

Related U.S. Application Data
(60) Provisional application No. 61/721,195, filed on Nov. 1, 2012.

(51) Int. Cl. C04B 16/04

(52) U.S. Cl. CPC C04B 16/04
USPC 524/5; 524/8

(57) ABSTRACT

Disclosed is a cementitious material that possesses favorable adhesion and compressive strength properties and is suitable for cold weather applications. Disclosed also are methods for the manufacture and use of the material.

### CROSS-REFERENCE TO RELATED APPLICATIONS

This application claims priority to and benefit under 35 U.S.C. §119(e) to U.S. Provisional Patent Application Ser. No. 61/721,195, filed on Nov. 1, 2012, in the name of the present inventor, this provisional application being incorporated herein by reference.

### FIELD OF THE INVENTION

The field relates to a cementitious material that possesses favorable adhesion and compressive strength properties and is suitable for cold weather applications.

### BACKGROUND OF THE INVENTION

There is a long-felt need for a cementitious material possessing favorable adhesion and compressive strength properties and suitable for cold weather applications.

In years to come, developed and developing nations are certain to continue investment for repair of existing concrete infrastructure components. As populations continue to increase, the utilization rates for existing infrastructure components are also projected to continually increase. Such increases in utilization rates not only subject the components to additional wear and tear, but such increases in utilization rates also lead to increased likelihood for timing conflicts regarding removing components from service for maintenance and repair type activities. For contemporary cementitious materials, the environment may also present conflicts for maintenance activities as contemporary cementitious materials typically require ambient temperatures a bit greater than the freezing point of water for successful application.

A material such as is described herein provides a cementitious material for concrete infrastructure repair in cold weather environments. A material such as is described herein differs from latex polymer modified cement based materials known in the art in that a material such as is described herein possesses sought-after properties when applied in cold weather environments. A material such as is described herein is accordingly useful for concrete infrastructure repair at a temperature below the freezing point of water. A material such as is described herein accordingly provides a means for significantly increasing the amount of time available for repair of cement based infrastructure components in cold weather climates. A material such as is described herein provides a material that can be cured below the minimum film forming temperature of a latex polymer included in the formulation of the material.

Polymer modified mortars (PMMs) using either powdered or aqueous cement modifiers are widely used as high-performance construction materials for finishing and repairing works because of their excellent workability, durability and improved adhesion performance. The improved mechanical property performance stems from the presence of tough, flexible polymer film dispersed somewhat uniformly throughout the material's microstructure. These polymers are film forming thermoplastic materials.

During film formation, polymer lattices tend to undergo an irreversible change from a stable colloidal dispersion to a continuous, transparent and mechanically stable film. The process of film formation is typically divided into three stages. Stage I is evaporation, in which the dispersion increases in density until the particles touch. The particles then undergo deformation to polyhedra in stage II. In stage III, the boundaries between the particles disappear through the interdiffusion of polymer chains, and the film develops its final strength.

Without wishing to be bound by theory, the inventor has determined that the film forming process for polymer modified cementitious materials varies from the aforementioned process of latex based paints and adhesives, due to the self-desiccating nature of cement hydration reactions. For polymer modified cementitious materials, water is removed in stage I through both hydration mechanisms and evaporative processes. This is especially advantageous for cold weather curing when utilizing aluminate cements, with examples not being limited to calcium sulfoaluminate (CSA) cement or calcium aluminate cement (CAC).

Decisions for selecting appropriate polymers for specific applications are often based upon both the polymer's glass transition temperature (T_{g}) and minimum film forming temperature (MFT). The MFT is typically close but not identical to the T_{g}. Below the MFT, the individual polymer particles are too rigid to undergo deformation resulting in brittle behavior and turbid appearance, not readily transforming into a homogenous film. Common methods for determining MFT consist of placing a thin layer of polymer in sufficient medium on a metal plate with a temperature gradient normally spanning the glass transition temperature of the polymer:
When films are cast on a metal bar with a temperature range spanning the glass transition temperature, a cloudy-clear transition is observed at a well-defined temperature. This temperature associated with the cloudy-clear point is found to move to lower temperatures with time, indicating a kinetically controlled process. Below a different temperature, typically a few degrees above the cloudy-clear point, the film cracks with a crack spacing that decreases to an asymptotic value with decreasing temperature. These transition temperatures are called minimum film formation temperatures (MFT). (Routh A. et al., Ind. Eng. Chem. Res. 2001, 40, 4302-4308).

Latex polymers are available with a wide range of T_{g}; however, polymers seldom possess a MFT less than the freezing point of water, as stages 1, 2 and 3 of the film formation process rely on the presence of a suitable medium. One major role of water in the film formation process is to provide a stabilizing and suspending medium for the particles that allows for thermal motion and particle mobility to permit approach to close packing of the particles at the point of contact or gelation of the array. If the MFT of the polymer dispersion is higher than the curing temperature, the polymer particles may not coalesce into a continuous film, but remain as closely packed polymer particles. Material failures or material defects occur when polymer particles do not coalesce into a continuous film.

Inclusion of latex polymers retards the hydration reactions associated with ordinary portland cement (OPC) based systems. Due to both the retarding effects and MFT criteria, latex polymer modified OPC systems are seldom utilized in cold weather applications, as the polymer particles are likely to become too rigid for film formation at some point after placement and before commencement of the exothermic hydration reaction. Latex polymer particles often become permanently damaged if they are frozen while in solution; so, even as little as one freeze/thaw cycle before formation of the permanent polymer film via stages 1, 2 and 3 of the aforementioned formation process may compromise a material's integrity over the long term. For these reasons, a need has existed for cementitious materials possessing hydration characteristics that create an environment favorable for latex polymer film formation when applied in cold weather environments.

Calcium sulfoaluminate (CSA) cement improves the performance of mortars at low temperature. However, the performance of latex polymer modified CSA cement materials in cold weather environments has not hitherto been established, nor, more generally, has there been a description of the performance of latex polymer modified blended cement materials in cold weather environments. On the other hand, it has been known in the art that a mortar containing a blend of CSA cement and OPC may possess favorable properties. CSA cements demonstrate different hydration characteristics when compared with OPC. The chemical water demand (CWD) for complete hydration of clinker is characteristically higher for CSAC when compared with OPC. During early hydration, CSA cements demonstrate a tendency for somewhat rapid desiccation primarily as a result of ettringite formation.

A material such as is described herein provides a rapid-setting material for use in cold weather applications where adhesion performance is paramount.

### SUMMARY OF THE INVENTION

A material such as is described herein provides inter alia a cementitious material that possesses favorable adhesion and compressive strength properties and is suitable for cold weather applications.

A material such as is described herein may comprise an aluminate cement and sufficient calcium sulfate to create an environment conducive to latex polymer film formation in a cold weather environment, such as an environment with ambient temperature below the freezing point of water.

A material such as is described herein may comprise an accelerating admixture, a retarding admixture, a plasticizing admixture, or a latex polymer, in addition to a hydraulic binding agent such as an aluminate cement. A material such as is described herein may be applied in a cold weather climate. The art has taught away from use of a latex polymer modified cementitious material in a cold weather environment. For example, ACI-548.1R-09, Guide for the use of Polymers in Concrete, suggests that polymer modified portland cement concrete (PPCC) should be placed when temperatures are between 45° F. (7° C.) and 85° F. (30° C.) because of the rate of hydration of the cement (ACI-548.1R-09).

In an embodiment of a material such as is described herein, an amount of a constituent material may be varied to control the enthalpy of reaction such that an acceptable degree of polymer film formation is achieved during application in a cold weather environment. An amount of a constituent material such as a plasticizing admixture, a latex polymer, a rheology modifier, an accelerating admixture, a retarding admixture or a filler may accordingly be varied. In an embodiment of a material such as is described herein, a cementitious material may be applied in a cold weather environment for any of the following end-uses: a pre-fabricated module, a sprayed concrete wall, a concrete block, a self-leveling underlayment, a stucco, a waterproof membrane, a pervious concrete, a crack isolation membrane, a tile grout, a sprayable cementitious system for use in underground construction, a polymer modified macro defect free material, a high performing patch and repair material, a concrete pour, or a pumpable cementitious system for a high rise building construction project.

A material such as is described herein may comprise an accelerating admixture. The percentage of accelerating admixture may be adjusted such that the enthalpy of reaction is sufficient for specific cold weather environments. The preferred concentration of accelerating admixture is 0.001% to 10%, more preferred is 1% to 5%, most preferred is 0.001% to 3%. It should be duly noted that increases in accelerating admixture concentration which successfully accelerates early age strength development often results in lower strengths at later ages when compared with like formulations containing lesser amounts of accelerating admixtures. The materials formulator should be prudent in defining the concentration of accelerating admixture necessary for ensuring proper latex polymer film formation in specific environments. Common examples of set accelerators or accelerating admixtures include but are not limited to lithium carbonate, calcium formate, quicklime, calcium oxide, sodium chloride, various alkali earth metals and their salts, aluminous materials when combined with other proper constituents, etc.

A material such as is described herein may comprise a plasticizing admixture. The percentage of plasticizing admixture may be adjusted such that the enthalpy of reaction is sufficient for specific cold weather environments. The preferred concentration of plasticizing admixture is 0.001% to 10%, more preferred is 1% to 5%, most preferred is 0.001% to 3%. Common materials used for such purposes are spray dried powders of modified polycarboxylic ether, melamine sulphonate formaldehyde condensates, naphthalene sulphonates, calcium lignosulphonates, sodium lignosulphonates, saccharose, sodium gluconate, sulphonic acids, carboxylates, poly-carboxylates, carboxylic acids, polyhydroxycarboxilic acids, sulphonated melamine or any other suitable material, whether it be naturally occurring or processed. Common examples are not limited to the Glennium family of products or the Melflux family of products.

A material such as is described herein may comprise a latex polymer. The percentage of latex polymer may be adjusted such that the enthalpy of reaction is sufficient for specific cold weather environments. The preferred concentration of latex polymer is 0.1% to 90%, more preferred is 3% to 50%, most preferred is 1% to 10%. Latex polymers include elastomeric latexes, thermoplastic latexes and thermosetting latexes or any combination thereof. Elastomeric latexes consist of natural and synthetic rubbers. Thermoplastic latexes are not limited to examples such as polyacrylic esters, copolymers of vinyl acetate/ethylene (VAE or EVA), terpolymers of vinyl acetate/ethylene/vinyl chloride (VAE/VC), terpolymers of vinyl acetate/ethylene/veova (VAE/Veova), VAE/Veova/VC, styrene acrylics, poly styrene acrylic esters, polyvinyl acetate, polyvinyl propionate, polypropylene, poly vinylidene chloride vinyl chloride (PVDC). Thermosetting latexes are not limited to epoxies. Examples of VAE liquid polymer dispersions are Vinnapas 526BP and Mowilith LDM 1852. An example of a styrene butadiene rubber (SBR) liquid polymer dispersion is Axilat SB500. An example of an acrylic liquid polymer dispersion is Axilat L8840.

A material such as is described herein may comprise a dispersible polymer powder. Dispersible polymer powders are characterized such that they disperse readily into their constituent polymer components when exposed to water thereby forming a tough, elastic water resistant polymer film. Examples of such products which are copolymers of vinyl acetate and ethylene (VAE) are Vinnapas 5044N and Vinnapas 5010N. A suitable example for a polymer powder of styrene butadiene rubber (SBR) chemistry is Axilat PSB150.

A material such as is described herein may comprise a retarding admixture. The percentage of retarding admixture may be adjusted such that the enthalpy of reaction is sufficient for specific cold weather environments. The preferred concentration of retarding admixture is 0.001% to 15%, more preferred is 1% to 5%, most preferred is 0.01% to 3%. Set retarders are often used to delay the hydration reactions associated with hydraulic binders and possibly reactions of other constituent components. Set retarders can vary in effectiveness of delaying onset or rapidity of hydration for differing hydraulic binders and/or different or varying combinations of constituent materials. Commonly used set retarders are not limited to tartaric acid, citric acid, sodium citrate, hydroxyl carboxylic acids and their salts, malic acid, sodium gluconate, sucrose, etc.

In the present context, the term “hydraulic binder” refers to a pulverized material in the solid, dry state, which when mixed with water yields mixtures which are able to set and harden, with a common example being the term “cement”. A hydraulic binder may comprise one or more individual component materials. A hydraulic binder may undergo setting and hardening when exposed to suitable medium. Utilizing cement chemistry nomenclature where C=CaO, Ś=SO₃, S=SiO₂, A=Al₂O₃, H=H₂O, F=Fe₂O₃, N=sodium based materials, K=potassium based materials, any of such hydraulic binder materials may hydrate to form materials containing C-A-Ś-H type phases and (N,K)-A-Ś-H type phases in addition to more traditional type phases common to ordinary portland cement hydration. Examples of such individual component materials should not be limited to all forms of calcium sulfate, hydrated lime, quicklime, alumina, alumina tri-hydrate, alite, belite, tri-calcium aluminate, yeelimite (kleins compound), calcium aluminate, C₁₂A₇, coal ash, slag, silica fume, pozzolana, clay, bauxite, red mud, brownmillerite or any other suitable material or combination of materials which when exposed to water or other suitable medium is able to set and harden. The term “cement” includes hydraulic and alite cements such as portland cement, blended cement, slag cement, pozzolanic cement, calcium aluminate cement, calcium sulfoaluminate cement or any other common cementing material or combination thereof.

A material such as is described herein may comprise a viscosity modifier. An embodiment of a material such as is described herein may also contain other materials such as viscosity modifiers commonly used in cementitious systems. These viscosity modifiers are typically polysaccharides and their derivatives including polysaccharide ethers soluble in water such as cellulose ether, starch ether (amylose and/or amylopectin and/or their derivatives), guar ether and/or dextrins. It is also possible to use synthetic polysaccharides such as anionic, non-ionic or cationic heteropolysaccharides such as xanthan gum or wellan gum. The polysaccharides can, but need not, be chemically modified with carboxymethyl groups, carboxyethyl groups, hydroxyethyl groups, hydroxypropyl groups, methyl groups, ethyl groups, propyl groups and/or long chain alkyl groups. Further natural stabilizing systems consist of alginates, peptides and/or proteins such as gelatin, casein and/or soy protein. Examples include dextrins, starch, starch ether, casein, soy protein, hydroxyl alkyl cellulose and/or alkyl hydroxalkyl cellulose. Other synthetic stabilizing systems include one or severtal polyvinyl pyrrolidones and/or polyvinyl acetals having molecular weights of approximately 2000 to 400,000; fully or partially saponified and/or modified fully or partially saponified poly-vinyl alcohols with a degree of hydrolysis of approximately 70 to 100 mole %, or in another respect approximately 80 to 98 mole %. Commonly referred to materials have been known to include methylhydroxyethylcellulose, hydroxymethylethylcellulose, hydroxyethylmethyl cellulose, carboxymethylcellulose, methylcellulose, ethylcellulose, hydroxyethylcellulose, hydroxyethylpropylcellulo se, MC, HEMC, etc.

A material such as is described herein may comprise a surfactant. An embodiment of a material such as is described herein may also contain other materials such as surfactants for various purposes, whether they be foaming materials, de-foaming materials or provide any other desired properties. Suitable foaming and stabilizing surfactants may include but are not limited to mixtures of an ammonium salt of an alkyl ether sulfate, a cocoamidopropyl betaine surfactant, a cocoamidopropyl dimethylamine, oxide surfactant, mixtures of an ammonium salt of an alkyl ether sulfate surfactant, a cocoamidopropyl hydroxysultaine surfactant, hydrolyzed keratin, an alkyl or alkene dimethylamine oxide surfactant, aqueous solutions of an alpha-olefinic sulfonate surfactant and a betaine surfactant and/or any other suitable materials. An example of a foaming material is ZONESEAL 2000 foaming additive commercially available from Halliburton.

A material such as is described herein may comprise a defoaming material. An embodiment of a material such as is described herein may also contain other materials such as defoaming materials which also may be known as air detrainers. These types of defoaming materials can be very important for creating impermeable coatings. These defoaming materials typically decrease the amount of entrained air within the designed system. Common examples of these materials are tributyl phosphate dibutyl phthalate, octyl alcohol, water insoluble esters of carbonic and boric acid as well as silicone based materials. Common examples of available defoamers include but are not limited to Agitan P800 and Surfynol MD600.

A material such as is described herein may comprise a “fugitive plasticizer” or a “coalescing solvent.” An embodiment of a material such as is described herein may also contain other materials such as “fugitive plasticizers” or “coalescing solvents” with a primary function being not limited to aiding the mechanisms for facilitating film formation or film integration during either the drying, setting, hardening or overall curing process. Some common “fugitive plasticizers” or “coalescing solvents” are volatile organic compounds not being limited to the examples including toluene, xylene, n-butyl acetate, ethoxyethyl acetate, ethyleneglycol monobutyl ether acetate, and diethyleneglycol monobutyl ether acetate.

A material such as is described herein may comprise a filling material. An embodiment of a material such as is described herein may also contain other materials such as filling materials. Typically, filling materials are finely ground materials. These fillers often possess, but should not be limited to a particle size distribution with both median and mean values less than 100 microns. This is one classification characteristic when comparing fine fillers and aggregate. Examples of common filling materials or fillers are ground carbonates with examples being calcium carbonate and sodium bi-carbonate, all classifications of clay materials, metakaolin, diatomaceous earth, carbon black, activated carbon, titanium dioxide, finely ground quartz, finely ground silica based materials often referred to as micro-silica, silica fume, fumed silica, kiln dust, pulverized stone, pulverized glass, ultra fine fly ash, fly ash, blast furnace slag, ground granulated blast furnace slag (GGBS), ground recycled materials, pulverized glass, crum rubber, recycled tires, powdered waste from recycling automobiles, powdered waste from recycling electronic components, etc.

A material according to the invention may also contain one or more common reinforcing materials typically used in either cementitious materials design or coating materials design such as fibrous materials or mesh type materials. Examples of fiber type materials should not be limited to metal fibers, organic fibers, synthetic fibers, polymeric fibers, carbon nano tube type fibrous materials or any mixture of fibers. Examples of fibers should not be limited to polyvinyl alcohol fibers (PVA), polyacrylonitrile fibers (PAN), polyethylene fibers (PE), high density polyethylene fibers (HDPE), polypropylene fibers (PP) or homo or co-polymers of polyamide or polyimide. Mixtures of any type of fibers may also be used, especially mixtures of fibers with different physical dimensions and different orientations. Addition of fibrous material to cementitious type mixtures may be facilitated by use of a viscosity modifying agent which ensures proper dispersal of fibers throughout the mixture, with an example being Kelco-Crete which is an anionic polysaccharide from CP Kelco. Furthermore, aramid type materials, not limited to currently available material forms such as pulp, yarn, fibers, or mesh, such potentially being comprised of chains with AABB configuration, with examples not being limited to Kevlar, Twaron, Nomex, New Star and Teijinconex, may be included in a multitude of possible arrays. Additionally, novel materials such as combinations of boron oxides and polyethylene may be utilized as means of reinforcement. Specifically designed and engineered mesh type materials, perhaps materials which require a specific degree of elongation for achieving optimum performance and are not currently commonly used as reinforcement in contemporary cementitious materials, may also be used as a means of reinforcement. Examples of mesh type materials should not be limited to metal mesh, alloy mesh, polymer mesh, fabric mesh, carbon fiber mesh, carbon nano-tube mesh, fiberglass mesh, polyethylene mesh, polypropylene mesh, aramid mesh or any combination thereof.

A material such as is described herein may also contain other materials such as materials sometimes needed for protection from microorganism attack. As a result, the mixing process may incorporate fungicides or anti-bacteria substances. Examples of such materials should not be limited to pentachlorophenol, sodium o-phenylphenate and/or various organic mercury compounds.

A material such as is described herein may also contain other materials such as flame-retarding materials. Examples of flame retarding materials should not be limited to chlorinated paraffin waxes and antimony trioxide.

A material such as is described herein may also contain other materials such as common aggregate materials not limited to specification of chemical composition or specimen geometry. Examples of common aggregate materials are siliceous materials with one specific example being silica sand, calcium based materials with an example being limestone, river gravel, river sand, pea gravel, pozzolanic material with an example being volcanic rock, bottom ash, cinders, along with numerous other possibilities for both recycled and manufactured aggregates. An embodiment of a material such as is described herein may also contain engineered aggregate materials such as high performance ceramic aggregate or light weight aggregate.

A material such as is described herein may also contain other materials such as antioxidants to retard deterioration of polymeric materials, perhaps surface active substances to enhance colloidal stability and ability to “wet out” surfaces. Coating materials may become exposed to acidic materials on the molecular level due to consequences from polymer hydrolysis, with one example being the liberation of hydrogen chloride. Common anti-oxidant materials should not be limited to phenyl-2-naphthylamine or carbon black. Common acid accepting substances for mix design purposes should not be limited to zinc oxide and calcium carbonate.

A material such as is described herein may also contain other materials such as anti-freeze materials not limited to ethylene glycol or glycerol.

A material such as is described herein may also incorporate corrosion inhibiting substances with one example not being limited to sodium benzoate.

A material such as is described herein may also contain other materials such as powdered metals, powdered alloys or powdered conductive materials for the purposes of producing a coating capable of conducting either electron, proton or neutron transfer in either continuous or dis-continuous fashion. Such conductive materials should not be limited to powder form, such conductive materials may also be added in the form of fibrous material, platy material, ground material, spherical material or virtually any geometry require for the given degree of conductivity.

A material such as is described herein may also contain other materials such as pigments, dyes or other common color enhancing additives.

A material such as is described herein may also include chemical materials with specific purpose such as alkali activating agents or polymer cross-linking agents. Examples of alkali activating agents should not be limited to sodium hydroxide, potassium hydroxide or magnesium hydroxide. Polymer cross-linking agents should not be limited to sodium borate and maleic anhydride.

A material such as is described herein may be prepared by any of a variety of temperatures and/or pressures appropriate for pertinent application mediums, constituent materials, substrate materials, application equipment, construction equipment or application environment in an effort to achieve desired properties, either thermodynamic, mechanical or other, for the applied cementitious material.

### BRIEF DESCRIPTION OF THE SEVERAL VIEWS OF THE DRAWINGS

FIG. 1 shows calorimeter analysis for cement pastes 3, 5 and 7 displayed in Table 1 highlighting the influence of lithium carbonate on the exothermic hydration reactions.

FIG. 2 shows calorimeter analysis for cement pastes 1, 2, 4, 6 and 8 displayed in Table 1 highlighting the influence of varying concentrations of constituent components on the exothermic nature of hydration reactions.

FIG. 3 shows calorimeter analysis for cement pastes 6, 7 and 8 displayed in Table 1 highlighting the influence of varying concentrations of constituent components on the exothermic nature of hydration reactions.

FIG. 4 shows calorimeter analysis for cement pastes 1 through 8 displayed in Table 1 highlighting the influence of varying concentrations of constituent components on the exothermic nature of hydration reactions.

FIG. 5 shows calorimeter analysis for cement paste 2 and cement paste 8 in Table 2 illustrating the influence of accelerating admixture concentration on exothermic nature of hydration reactions.

FIG. 6 shows calorimeter analysis for cement paste 1 and cement paste 8 in Table 2 illustrating the influence of plasticizer concentration on the exothermic nature of hydration reactions.

FIG. 7 shows calorimeter analysis for cement pastes 1, 2, 3, 4, 7 and 8 displayed in Table 2 illustrating the influence of varying concentrations of constituent components on the exothermic nature of the hydration reactions.

FIG. 8 shows adhesion test specimens cast over concrete substrate cured outdoors in temperatures below the freezing point of water.

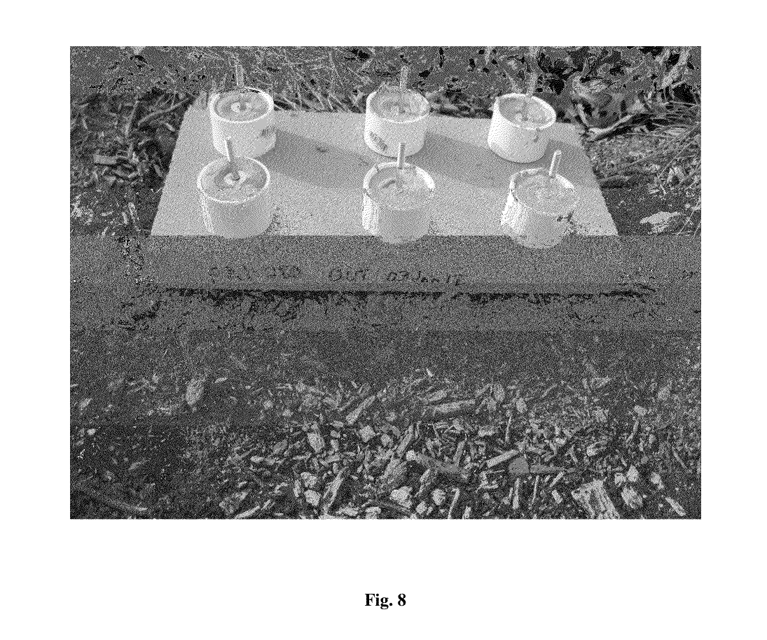

FIG. 9 shows concrete substrate material being tested following a variant of ASTM C1583.

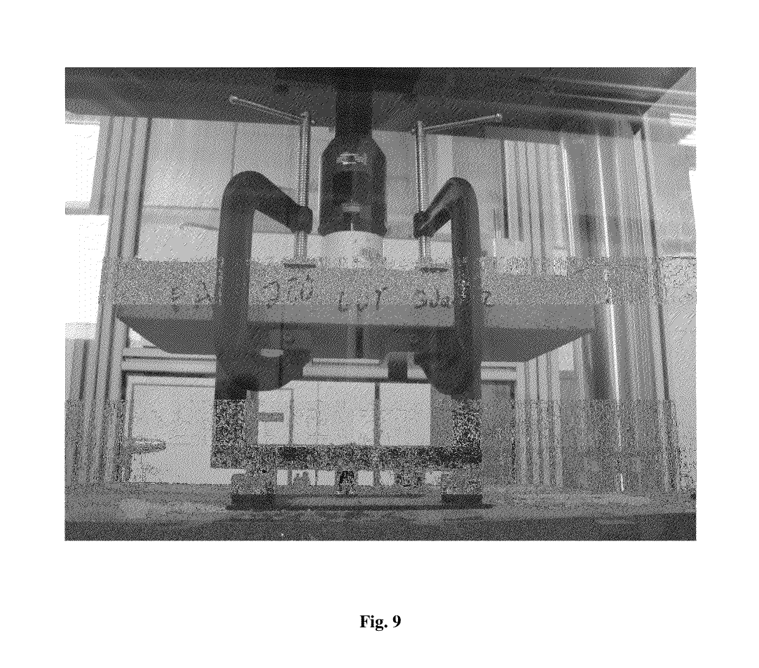

FIG. 10 shows a bar graph showing the results of ASTM C307 direct tensile strength test of polymer modified cement mortar 2 cured at ambient indoor conditions.

FIG. 11 shows a bar graph showing the results of ASTM 1583 variant pull off test of polymer modified cement mortar 2 cast over concrete substrate 2 cured “IN” at 75° F. (24° C.) and “OUT” at 25° F. (−4° C.) for approximately 24 hours.

FIG. 12 shows pull off test specimens for cement mortar 2 plus polymer 2 displaying both mortar failure (CF/A) and substrate failure (CF/S) after curing for 20 hours outdoors below the freezing point of water and 4 hours indoors above the freezing point of water immediately before testing.

FIG. 13 shows pull off test specimens for cement mortar 2 plus polymer 2 displaying substrate failure, CF/S, after curing for 24 hours indoors above the freezing point of water.

FIG. 14 shows pull off test specimens for cement mortar 2 plus polymer 3 displaying substrate failure (CF/S) after curing for 20 hours outdoors below the freezing point of water and 4 hours indoors above the freezing point of water immediately before testing.

FIG. 15 shows pull off test specimens for cement mortar 2 plus polymer 3 displaying substrate failure after curing for 24 hours indoors above the freezing point of water.

FIG. 16 shows pull off test specimens for cement mortar 2 plus polymer 4 displaying both mortar failure (CF/A) and substrate failure (CF/S) after curing for 20 hours outdoors below the freezing point of water and 4 hours indoors above the freezing point of water immediately before testing.

FIG. 17 shows pull off test specimens for cement mortar 2 plus polymer 4 displaying substrate failure (CF/S) after curing for 24 hours indoors above the freezing point of water.

### DETAILED DESCRIPTION OF THE PREFERRED EMBODIMENTS

A material such as is described herein will be described more fully hereinafter. A material such as is described herein may, however, be embodied in many different forms and should not be construed as limited to the embodiments set forth herein; rather, these embodiments are provided so that this disclosure will be thorough and complete, and will fully convey the scope of a material such as is described herein to those skilled in the art. As used in this specification and the claims, the singular forms “a,” “an,” and “the” include plural referents unless the context clearly dictates otherwise. “Or” as in “A or B” is conjunctive, not disjunctive, and accordingly in this instance means at least one member of the set {A, B}.

A material such as is described herein provides inter alia a cementitious material that possesses favorable adhesion and compressive strength properties and is suitable for cold weather applications.

In an embodiment, the making of a material such as is described herein comprises formation of a mixture comprising calcium sulfoaluminate (CSA) cement (and optionally additional hydraulic binding agent(s)), a plasticizing admixture(s), an accelerating admixture(s), a retarding admixture(s), latex polymer(s), rheology modifier(s), fiiler(s), surfactant(s) and aggregate such that the percentage by mass of the hydraulic binding agents is from 0.1% to 90%, the percentage by mass of accelerating admixtures is from 0.001% to 10%, the percentage by mass of retarding admixtures is from 0.001% to 10%, the percentage by mass of plasticizing agents is from 0.001% to 10%, the percentage by mass of surfactants is from 0.001% to 10%, the percentage by mass of fillers is from 0.1% to 90%, the percentage by mass of latex polymers is from 0.1% to 90% and the percentage by mass of aggregate is from 1% to 90%.

In an embodiment, the making of a material such as is described herein comprises formation of a mixture comprising calcium sulfoaluminate (CSA) cement, additional hydraulic binding agent(s), a plasticizing admixture(s), an accelerating admixture(s), a retarding admixture(s), latex polymer(s), rheology modifier(s), fiiler(s), surfactant(s) and aggregate such that the percentage by mass of the hydraulic binding agents is from 0.1% to 90%, the percentage by mass of accelerating admixtures is from 0.001% to 10%, the percentage by mass of retarding admixtures is from 0.001% to 10%, the percentage by mass of plasticizing agents is from 0.001% to 10%, the percentage by mass of surfactants is from 0.001% to 10%, the percentage by mass of fillers is from 0.1% to 90%, the percentage by mass of latex polymers is from 0.1% to 90% and the percentage by mass of aggregate is from 1% to 90%.

In an embodiment, the making of a material such as is described herein comprises formation of a mixture comprising calcium sulfoaluminate (CSA) cement, additional hydraulic binding agent(s), a plasticizing admixture(s), an accelerating admixture(s), a retarding admixture(s), latex polymer(s), rheology modifier(s), surfactant(s) and filler such that the percentage by mass of the hydraulic binding agents is from 0.1% to 90%, the percentage by mass of accelerating admixtures is from 0.001% to 10%, the percentage by mass of retarding admixtures is from 0.001% to 10%, the percentage by mass of plasticizing agents is from 0.001% to 10%, the percentage by mass of surfactants is from 0.001% to 10%, the percentage by mass of fillers is from 0.1% to 90% and the percentage by mass of latex polymers is from 0.1% to 90%.

In an embodiment, the making of a material such as is described herein comprises formation of a mixture comprising calcium sulfoaluminate (CSA) cement, additional hydraulic binding agent(s), a plasticizing admixture(s), an accelerating admixture(s), a retarding admixture(s), latex polymer(s), rheology modifier(s), surfactant(s) and aggregate such that the percentage by mass of the hydraulic binding agents is from 0.1% to 90%, the percentage by mass of accelerating admixtures is from 0.001% to 10%, the percentage by mass of retarding admixtures is from 0.001% to 10%, the percentage by mass of plasticizing agents is from 0.001% to 10%, the percentage by mass of surfactants is from 0.001% to 10%, the percentage by mass of latex polymers is from 0.1% to 90% and the percentage by mass of aggregate is from 1% to 90%.

In an embodiment, the making of a material such as is described herein comprises formation of a mixture comprising calcium sulfoaluminate (CSA) cement, additional hydraulic binding agent(s), a plasticizing admixture(s), an accelerating admixture(s), a retarding admixture(s), latex polymer(s), rheology modifier(s), fiiler(s), surfactant(s), reinforcing materials and aggregate such that the percentage by mass of the hydraulic binding agents is from 0.1% to 90%, the percentage by mass of accelerating admixtures is from 0.001% to 10%, the percentage by mass of retarding admixtures is from 0.001% to 10%, the percentage by mass of plasticizing agents is from 0.001% to 10%, the percentage by mass of surfactants is from 0.001% to 10%, the percentage by mass of fillers is from 0.1% to 90%, the percentage by mass of latex polymers is from 0.1% to 90% and the percentage by mass of aggregate is from 1% to 90%.

In an embodiment, the making of a material such as is described herein comprises formation of a mixture comprising calcium sulfoaluminate (CSA) cement, additional hydraulic binding agent(s), a plasticizing admixture(s), an accelerating admixture(s), a retarding admixture(s), latex polymer(s), rheology modifier(s), fiiler(s), surfactant(s), material(s) to add color and aggregate such that the percentage by mass of the hydraulic binding agents is from 0.1% to 90%, the percentage by mass of accelerating admixtures is from 0.001% to 10%, the percentage by mass of retarding admixtures is from 0.001% to 10%, the percentage by mass of plasticizing agents is from 0.001% to 10%, the percentage by mass of surfactants is from 0.001% to 10%, the percentage by mass of fillers is from 0.1% to 90%, the percentage by mass of latex polymers is from 0.1% to 90% and the percentage by mass of aggregate is from 1% to 90%.

In an embodiment, the making of a material such as is described herein comprises formation of a mixture comprising calcium sulfoaluminate (CSA) cement, additional hydraulic binding agent(s), a plasticizing admixture(s), an accelerating admixture(s), a retarding admixture(s), latex polymer(s), rheology modifier(s), fiiler(s), surfactant(s), material(s) to add conductivity and aggregate such that the percentage by mass of the hydraulic binding agents is from 0.1% to 90%, the percentage by mass of accelerating admixtures is from 0.001% to 10%, the percentage by mass of retarding admixtures is from 0.001% to 10%, the percentage by mass of plasticizing agents is from 0.001% to 10%, the percentage by mass of surfactants is from 0.001% to 10%, the percentage by mass of fillers is from 0.1% to 90%, the percentage by mass of latex polymers is from 0.1% to 90% and the percentage by mass of aggregate is from 1% to 90%.

In an embodiment, the making of a material such as is described herein comprises formation of a mixture comprising calcium sulfoaluminate (CSA) cement, additional hydraulic binding agent(s), a plasticizing admixture(s), an accelerating admixture(s), a retarding admixture(s), latex polymer(s), rheology modifier(s), fiiler(s), surfactant(s), material(s) to inhibit corrosion and aggregate such that the percentage by mass of the hydraulic binding agents is from 0.1% to 90%, the percentage by mass of accelerating admixtures is from 0.001% to 10%, the percentage by mass of retarding admixtures is from 0.001% to 10%, the percentage by mass of plasticizing agents is from 0.001% to 10%, the percentage by mass of surfactants is from 0.001% to 10%, the percentage by mass of fillers is from 0.1% to 90%, the percentage by mass of latex polymers is from 0.1% to 90% and the percentage by mass of aggregate is from 1% to 90%.

In an embodiment, the making of a material such as is described herein comprises formation of a mixture comprising calcium sulfoaluminate (CSA) cement, additional hydraulic binding agent(s), a plasticizing admixture(s), an accelerating admixture(s), a retarding admixture(s), latex polymer(s), rheology modifier(s), fiiler(s), surfactant(s), material(s) for reinforcement and aggregate such that the percentage by mass of the hydraulic binding agents is from 0.1% to 90%, the percentage by mass of accelerating admixtures is from 0.001% to 10%, the percentage by mass of retarding admixtures is from 0.001% to 10%, the percentage by mass of plasticizing agents is from 0.001% to 10%, the percentage by mass of surfactants is from 0.001% to 10%, the percentage by mass of fillers is from 0.1% to 90%, the percentage by mass of latex polymers is from 0.1% to 90% and the percentage by mass of aggregate is from 1% to 90%.

In an embodiment, the making of a material such as is described herein comprises formation of a mixture comprising calcium sulfoaluminate (CSA) cement, additional hydraulic binding agent(s), a plasticizing admixture(s), an accelerating admixture(s), a retarding admixture(s), latex polymer(s) and any recycled material and/or any sole constituent material or combination constituent materials such that the percentage by mass of the hydraulic binding agents is from 0.1% to 90%, the percentage by mass of accelerating admixtures is from 0.001% to 10%, the percentage by mass of retarding admixtures is from 0.001% to 10%, the percentage by mass of plasticizing agents is from 0.001% to 10%, and the percentage by mass of latex polymers is from 0.1% to 90% while the percentage by mass of additional constituent material(s) comprises the remainder of the mass percentage such that the summation of mass percentages for all constituent materials equals 100%.

In an embodiment, the making of a material such as is described herein comprises formation of a mixture comprising calcium sulfoaluminate (CSA) cement, additional hydraulic binding agent(s), a plasticizing admixture(s), an accelerating admixture(s), a retarding admixture(s), latex polymer(s) and any sole constituent material or combination constituent materials such that the percentage by mass of the hydraulic binding agents is from 0.1% to 90%, the percentage by mass of accelerating admixtures is from 0.001% to 10%, the percentage by mass of retarding admixtures is from 0.001% to 10%, the percentage by mass of plasticizing agents is from 0.001% to 10%, and the percentage by mass of latex polymers is from 0.1% to 90% while the percentage by mass of additional constituent material(s) comprises the remainder of the mass percentage such that the summation of mass percentages of all constituent materials equals 100%.

In an embodiment, the making of a material such as is described herein comprises formation of a mixture comprising aluminate cement, additional hydraulic binding agent(s), a plasticizing admixture(s), an accelerating admixture(s), a retarding admixture(s), latex polymer(s) and any sole constituent material or combination constituent materials such that the percentage by mass of the hydraulic binding agents is from 0.1% to 90%, the percentage by mass of accelerating admixtures is from 0.001% to 10%, the percentage by mass of retarding admixtures is from 0.001% to 10%, the percentage by mass of plasticizing agents is from 0.001% to 10%, and the percentage by mass of latex polymers is from 0.1% to 90% while the percentage by mass of additional constituent material(s) comprises the remainder of the mass percentage such that the summation of mass percentages of all constituent materials equals 100%.

The following examples are meant for illustrative purposes.

In an example, each of various embodiments of a material such as is described herein was prepared from, as hydraulic binding agents, CSA cement containing C₃A and Type I ordinary Portland cement; as anhydrite, Snow white filler sourced from United States Gypsum (USG) with average particle size in the range of 7 to 9 microns (USG TDS); as gypsum, Terra Alba gypsum sourced from United States Gypsum (USG) with average particle size in the range of 12 to 15 microns (USG TDS); as aggregate, ASTM finely graded sand from Ottawa Ill. and a coarser, 20/30 sand; as substrate material, an ordinary Portland cement based patio block sourced from Lowes; and as polymer, “Polymer 2” denoting vinyl acetate/ethylene with T_{g}=−7° C. (19° F.) and MFT=0° C. (32° F.); “Polymer 3” denoting acrylic with T_{g}=−10° C. (14° F.) and MFT=0° C. (32° F.); or “Polymer 4” denoting styrene butadiene rubber with T_{g}=15° C. (59° F.) and MFT=8° C. (46° F.).

A process such as is described herein allows for the enthalpy of reaction for hydraulic binding agents and various other constituents to be controlled through selection and mixing of various constituents, not limited to accelerating admixtures, retarding admixtures, plasticizing admixtures and latex polymer, such that acceptable degrees of latex polymer film formation is achieved in cold weather climates. In addition, a material such as is described herein possesses favorable adhesion characteristics and direct tensile strength performance when the material is prepared by curing mixed constituents below the freezing point of water.

Direct tensile strength testing was performed according to ASTM C307, Standard Test Method for Tensile Strength of Chemical Resistant Mortars, Grouts and Monolithic Surface Coatings. Adhesion testing was performed on samples cured below the freezing point of water using a variant of ASTM C1583, Standard Test Method for Tensile Strength of Concrete Surfaces and the Bond Strength or Tensile Strength of Concrete Repair and Overlay Materials by Direct Tension (Pull-off Method).

Table 1 displays cement paste formulations for calorimeter analysis. The resultant information demonstrated that enthalpy of reaction was controlled by varying formulation constituents.

TABLE 1
Cement paste formulations for calorimeter analysis

| Channel/ | | | | | | | | |
|---|---|---|---|---|---|---|---|---|
| Component | | | | | | | | |
| (mass (g)) | 1 | 2 | 3 | 4 | 5 | 6 | 7 | 8 |
| CSA Cement | 20 | 20 | 20 | 20 | 20 | 20 | 20 | 16 |
| Anhydrite | 5.25 | 5.25 | 5.25 | 5.25 | 5.25 | 5.25 | 5.25 | 5.25 |
| Gypsum | 0.75 | 0.75 | 0.75 | 0.75 | 0.75 | 0.75 | 0.75 | 0.75 |
| VAE Tg = | | 4 | | 4 | | 4 | | 4 |
| −7° C. | | | | | | | | |
| VAE Tg = | | | 4 | | 4 | | 4 | |
| 20° C. | | | | | | | | |
| Lithium | | | | | | 0.03 | 0.03 | 0.03 |
| Carbonate | | | | | | | | |
| Super | | | | 0.08 | 0.08 | 0.08 | 0.08 | 0.08 |
| plasticizer | | | | | | | | 4 |
| OPC | | | | | | | | |
| Silica Fume | | | | | | | | 2.5 |
| Tartaric Acid | | | | | | 0.03 | 0.03 | 0.03 |
| Water | 8 | 8 | 8 | 8 | 8 | 8 | 8 | 11 |

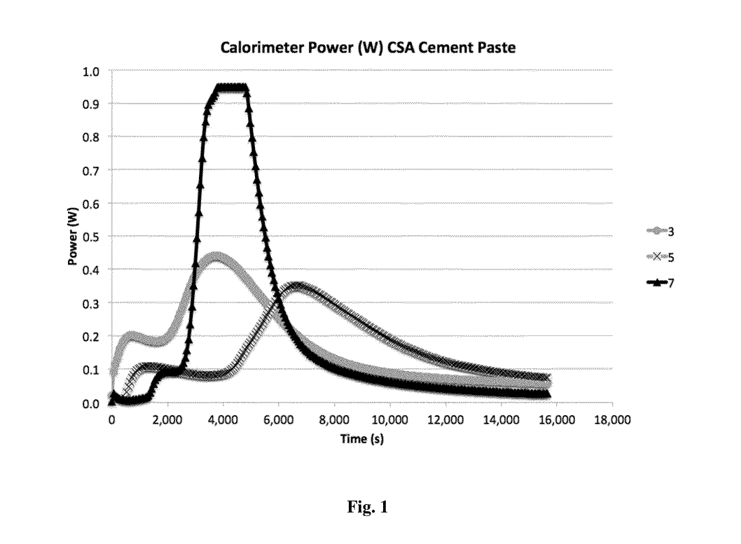

FIG. 1 displays calorimeter analysis for polymer modified cement pastes varying the concentrations of certain constituents. As shown in FIG. 1, addition of plasticizing and accelerating admixtures influenced the enthalpy of reaction. Cement paste formulation 3 contained, other than water, only CSA cement, calcium sulfate and latex polymer. Cement paste formulation 4 contained, other than water, CSA cement, calcium sulfate, latex polymer and plasticizer. Cement paste 7 contained, other than water, CSA cement, calcium sulfate, latex polymer, plasticizer, an accelerating admixture and a retarding admixture. The plateau associated with the cement paste 7 curve in FIG. 1 resulted from exceeding the maximum recording settings of the calorimeter.

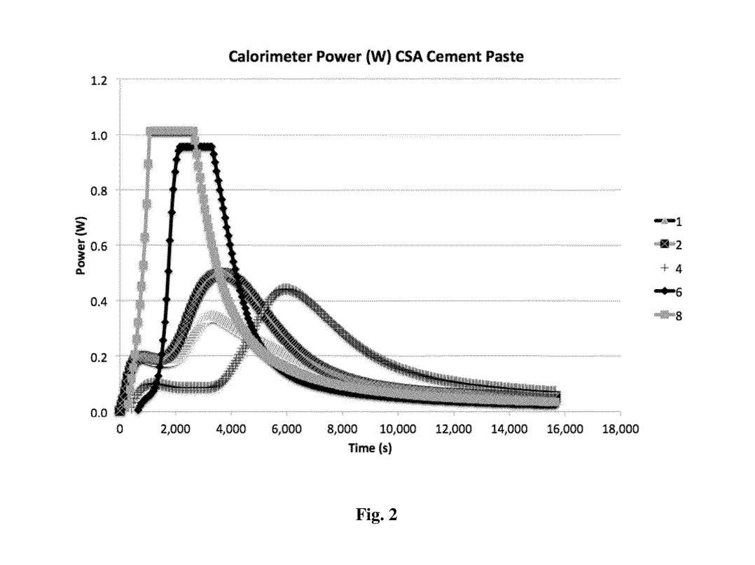

FIG. 2 displays calorimeter analysis for polymer modified cement pastes varying the concentrations of certain constituents. As shown in FIG. 2, addition of plasticizing and accelerating admixtures influenced the enthalpy of reaction. Cement paste formulation 1 contained, other than water, only CSA cement and calcium sulfate. Cement paste 2 contained, other than water, CSA cement, calcium sulfate and latex polymer. Cement paste formulation 4 contained, other than water, CSA cement, calcium sulfate, latex polymer and plasticizer. Cement paste 6 contained, other than water, CSA cement, calcium sulfate, latex polymer, plasticizer, an accelerating admixture and a retarding admixture. Cement paste 8 contained, other than water, CSA cement, ordinary Portland cement (OPC), calcium sulfate, pozzolanic material, latex polymer, plasticizer, accelerating admixtures and a retarding admixture. As shown in FIG. 2, polymer modified mortars containing accelerating admixtures liberated the most energy during hydration. Cement paste 8 containing a blend of cements, polymer, accelerating admixtures and pozzolanic material displayed the quickest onset of reaction. The plateaus associated with the curves for cement pastes 6 and 8 in FIG. 2 resulted from exceeding the maximum recording settings of the calorimeter.

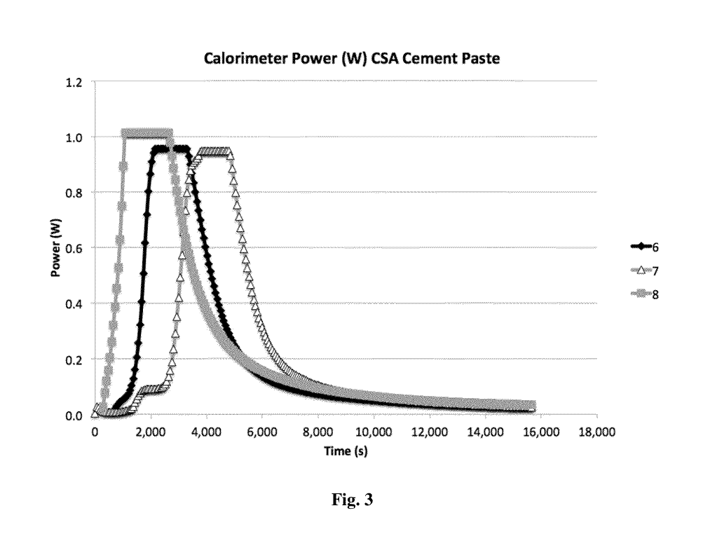

FIG. 3 displays calorimeter analysis for polymer modified cement pastes varying the concentrations of certain constituents. As shown in FIG. 3, varying the amount and type of constituents influenced the nature of associated hydration reactions. Cement paste 6 contained, other than water, CSA cement, calcium sulfate, latex polymer with T_{g}=−7° C., plasticizer, an accelerating admixture and a retarding admixture. Cement paste 7 contained, other than water, CSA cement, calcium sulfate, latex polymer with T_{g}=18° C., plasticizer, an accelerating admixture and a retarding admixture. A notable difference between cement paste 6 and cement paste 7 is the difference in the glass transition temperature (T_{g}) of the dispersible polymer powders contained therein. Cement paste 8 contained, other than water, CSA cement, ordinary Portland cement (OPC), calcium sulfate, pozzolanic material, latex polymer, plasticizer, accelerating admixtures and a retarding admixture. The information displayed in FIG. 3 further illustrates that through a process such as is described herein one may exert control over performance of the hydration reactions by varying type and quantity of constituents. For example, cement paste 8 containing a blend of cements, accelerating admixtures, retarding admixtures, pozzolanic material and latex polymer displays the earliest onset of reaction while also being the first to liberate enough energy to exceed the recording capabilities of the calorimeter. The plateaus associated with the curves for cement pastes 6, 7 and 8 in FIG. 3 resulted from exceeding the maximum recording settings of the calorimeter.

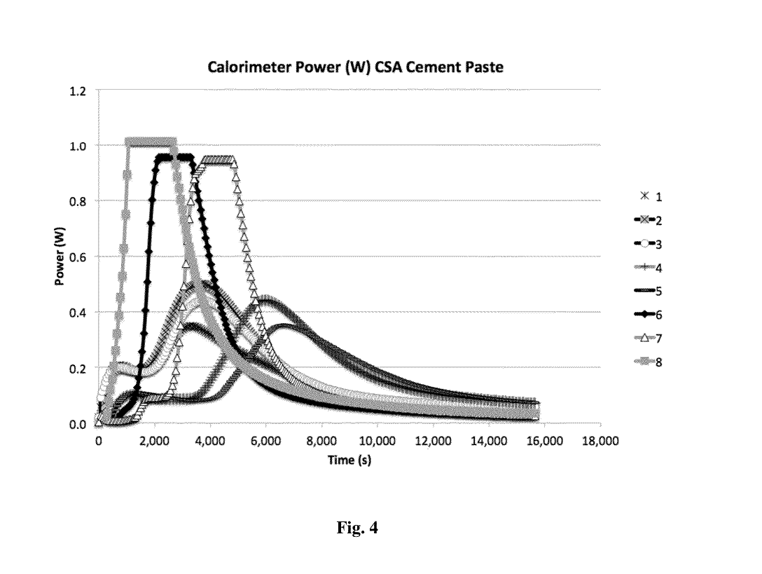

FIG. 4 displays calorimeter analysis for all cement paste formulations displayed in Table 1. FIG. 4 illustrates the influence of type and concentration of constituents on the exothermic nature of associated hydration reactions. The formulations containing accelerating admixtures displayed the greatest exothermic reactions. The information displayed in FIG. 4 further illustrates that through a process such as is described herein one may exert control over performance of the hydration reactions by varying type and quantity of constituents, leading to an acceptable degree of polymer film formation in cold weather environments. The plateaus associated with the curves for cement pastes 6, 7 and 8 in FIG. 4 resulted from exceeding the maximum recording settings of the calorimeter.

TABLE 2
Cement paste formulations for calorimeter analysis demonstrating the
influence of accelerating admixture concentration, plasticizing admixture
concentration and water concentration on the exothermic nature of
hydration reactions

| Channel/ | | | | | | |
|---|---|---|---|---|---|---|
| Component | | | | | | |
| (mass (g)) | 1 | 2 | 3 | 4 | 7 | 8 |
| CSA Cement | 20 | 20 | 20 | 20 | 20 | 16 |
| Anhydrite | 5.25 | 5.25 | 5.25 | 5.25 | 5.25 | 5.25 |
| Gypsum | 0.75 | 0.75 | 0.75 | 0.75 | 0.75 | 0.75 |
| VAE Tg = −7° C. | 4 | 4 | 4 | 4 | 4 | 4 |
| Lithium | 0.03 | 0.06 | 0.06 | 0.09 | 0.06 | 0.03 |
| Carbonate | | | | | | |
| Superplasticizer | 0.1 | 0.1 | 0.1 | 0.10 | 0.15 | 0.15 |
| Tartaric Acid | 0.08 | 0.08 | 0.08 | 0.08 | 0.08 | 0.08 |
| Water | 10 | 10 | 14 | 10 | 14 | 10 |

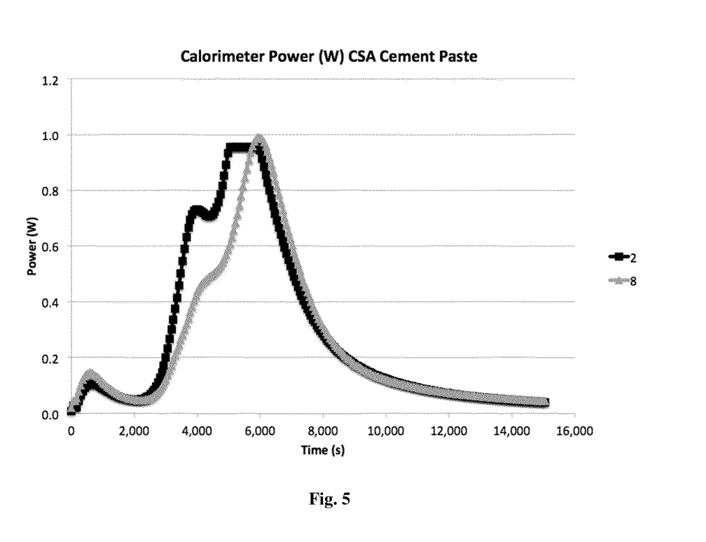

FIG. 5 displays calorimeter analysis for cement paste 2 and cement paste 8 in Table 2 illustrating the influence of both accelerating admixture concentration and plasticizer concentration on the exothermic nature of hydration reactions. As seen in FIG. 5, cement paste 2 containing the greater amount of accelerating admixture liberated the most energy during early age hydration. The plateaus associated with the curves for cement pastes 2 and 8 in FIG. 5 resulted from exceeding the maximum recording settings of the calorimeter.

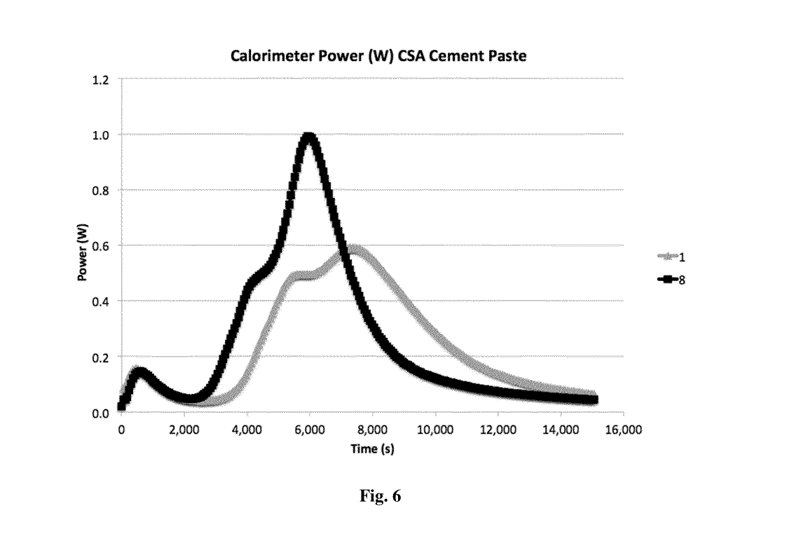

FIG. 6 displays calorimeter analysis for cement paste 1 and cement paste 8 in Table 2 illustrating the influence of plasticizer concentration on the exothermic nature of hydration reactions. As seen in FIG. 6, cement paste 8 containing the greater amount of plasticizing admixture liberated the most energy during early age hydration. The information displayed in FIG. 6 further illustrates that through a process such as is described herein one may exert control over performance of the hydration reactions by varying type and quantity of constituents.

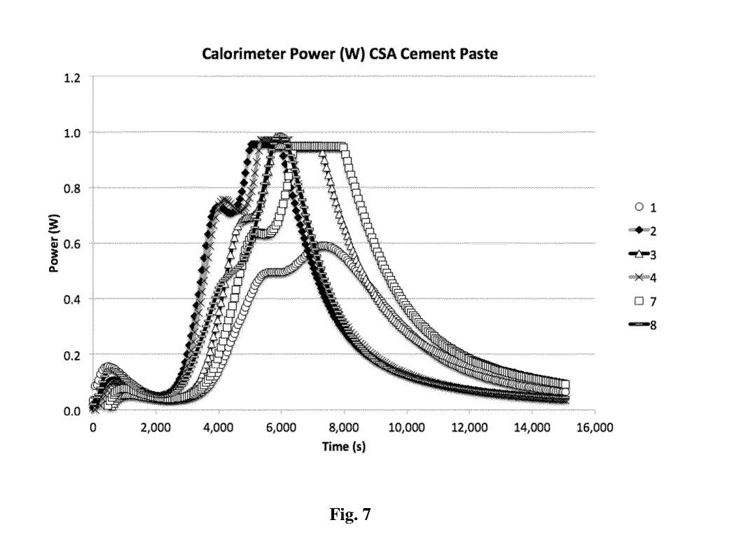

FIG. 7 displays calorimeter analysis for cement pastes 1, 2, 3, 4, 7 and 8 in Table 2 further illustrating that through a process such as is described herein one may exert control over performance of the hydration reactions by varying type and quantity of constituents, for preparation of high performing latex polymer modified cementitious materials for use in cold weather climates. The plateaus associated with the curves for cement pastes in FIG. 7 resulted from exceeding the maximum recording settings of the calorimeter.

Adhesion testing was performed using a variant of ASTM C1583, Standard Test Method for Tensile Strength of Concrete Surfaces and the Bond Strength or Tensile Strength of Concrete Repair and Overlay Materials by Direct Tension (Pull-off Method). An Instron universal testing machine outfitted with a special jig for pull-off testing was utilized for data collection. Adhesion test specimens were cast by placing wet mortar into standard 1.5 in (38 mm) diameter PVC pipe couplings atop a substrate material immediately after mixing. Instead of using steel anchors and epoxy, standard, coarse thread bolts 3 in (76 mm) in length were placed into the center of wet mortar castings such that the bolt head was immediately adjacent to the substrate material. After the bolts were placed in the wet mortar, standard washers were gently slid down over the bolts such that the washers rested on the surface of the wet mortar in an effort to ensure the bolts remained perpendicular to the substrate material during the hydration process. Adhesion specimens were tested after curing either outside below the freezing point of water or inside above the freezing point of water for approximately 24 hours. The samples cured outside were placed outside immediately after casting. These samples were cured outside below the freezing point of water for 20 hours before being moved inside for four hours of equilibration at ambient laboratory temperature immediately before testing. Six adhesion samples were tested for each polymer modified mortar. Substrate materials for indoor and outdoor samples were identical in specifications and had been stored at ambient laboratory conditions for a period greater than 28 days at the time of casting.

Cement mortar 2 is a polymer modified “minimum defect” material based upon a blend of cements for improved hydration performance. In general terms, cement mortar 2 contains a blend of CSA cement and OPC, anhydrite, gypsum, silica fume, superplasticizer, aggregate and a few additional minor components for ensuring acceptable hydration performance. A constant mass amount of polymer 2, polymer 3 or polymer 4 was added to cement mortar 2 for adhesion testing. The polymer/cement ratio for each mortar was 0.15. The water/cement ratio for each mortar was 0.42. Table 3 lists the mortars analyzed in this experiment.

For preparing the dry mix mortars, individual mortar components were weighed and placed into a plastic mixing bag. After all components were added, the bag was sealed and shaken vigorously by hand for approximately ninety seconds. This type of mixing is an industry proven simulation for blending operations in the manufacturing of dry mix mortar products containing minute quantities of additives such as accelerators and retarders.

For direct tensile strength testing, experimental specimens were cast according to ASTM C307. Three test specimens were cast for each test series. During the first 24 hours of curing, each test specimen remained in the mold covered with plastic on the workbench. After this initial curing period, test specimens were removed from their molds and tested.

TABLE 3
Mortars tested in the adhesion study

| | cement mortar | cement mortar | cement mortar |
|---|---|---|---|
| | 2 + polymer 2 | 2 + polymer 3 | 2 + polymer 4 |
| Materials | mass (g) | mass (g) | mass (g) |
| CSA Cement | 400 | 400 | 400 |
| OPC | 100 | 100 | 100 |
| Anhydrite | 140 | 140 | 140 |
| Gypsum | 20 | 20 | 20 |
| VAE (Polymer 2) | 100 | | |
| Acrylic (Polymer 3) | | 100 | |
| SBR (Polymer 4) | | | 100 |
| Sand | 1500 | 1500 | 1500 |
| Lithium Carbonate | 1.5 | 1.5 | 1.5 |
| Superplasticizer | 6 | 6 | 6 |
| Tartaric Acid | 2 | 2 | 2 |
| Silica Fume | 60 | 60 | 60 |
| Water | 280 | 280 | 280 |
| p/c | 0.15 | 0.15 | 0.15 |
| w/c | 0.42 | 0.42 | 0.42 |

The “OUT” samples were prepared and placed outside early in the afternoon of a first day. The “OUT” samples were moved inside late in the morning of the following day. After being placed outside on the first day, the “OUT” samples were not exposed to temperatures above the freezing point of water until they were moved inside approximately four hours before testing on the following day.

The results of this series of experiments compare and contrast mortar direct tensile strength with mortar pull off strength in an effort to document source of material failure in each pull off test. Typically, with such a sample configuration, a cement mortar will fail through any of three mechanisms during pull off testing:

1. CF/A=cohesive failure within the adhesive

2. CF/S=cohesive failure within the substrate

3. AF/S=adhesive failure with the substrate

The CF/A failure mode results when the direct tensile strength of the mortar is less than both the bond strength between the mortar and substrate and the direct tensile strength of the substrate. The CF/S failure mode results when both the direct tensile strength of the mortar and the bond strength between the mortar and substrate is greater than the direct tensile strength of the substrate. The AF/S failure mode results when the bond strength between the mortar and substrate is less than either the direct tensile strength of the mortar or the direct tensile strength of the substrate material.

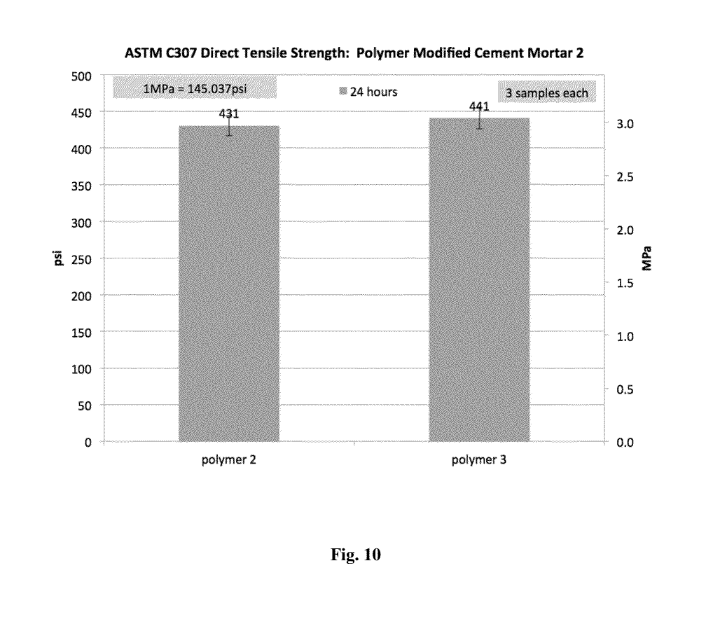

FIG. 10 displays direct tensile strength information for cement mortar 2 plus polymer 2 or 3. Adhesion testing exhausted the supply of polymer 4 before direct tensile strength dog bone samples for 24 hour testing could be cast. A similar CSA cement mortar formulation including polymer 4 displayed a direct tensile strength of about 350 psi after curing at ambient indoor conditions for 24 hours. As seen in FIG. 10, polymer modified cement mortar 2 plus polymer 2 or polymer 3 displayed average direct tensile strength value of 431 psi (2.97 MPa) or 441 psi (3.04 MPa), respectively.

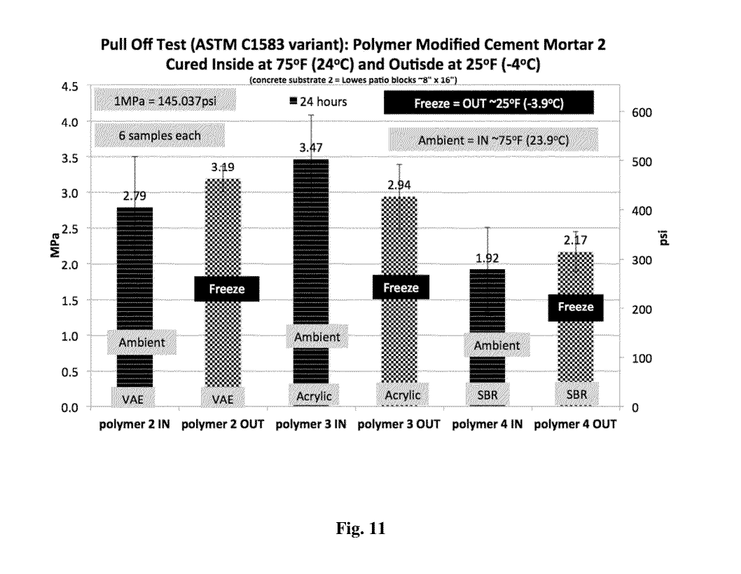

As displayed in FIG. 11, when cured indoors for 24 hours, cement mortar 2 plus polymer 2, 3 or 4 cast over porous concrete substrate displayed average pull-off strength value of 2.79 MPa (405 psi), 3.47 MPa (503 psi) or 1.92 MPa (279 psi), respectively. All mortars cured inside above the freezing point of water displayed pull-off sample failure modes within the substrate, or CF/S. When cured outdoors for 20 hours and moved indoors for 4 hours, cement mortar 2 plus polymer 2, 3 or 4 displayed average pull-off strength value of 3.19 MPa (463 psi), 2.94 MPa (426 psi) or 2.17 MPa (315 psi), respectively. Cement mortar 2 plus polymer 2 cured below the freezing point of water displayed failure modes both within the mortar, CF/A, and within the substrate, CF/S. Cement mortar 2 plus polymer 3 or 4 cured below the freezing point of water displayed pull-off sample failure mode within the substrate, or CF/S.

There is a long-felt need for a process enabling a latex polymer to undergo a favorable degree of film formation when applied below the polymer's minimum film forming temperature (MFT) and below the freezing point of water. Without wishing to be bound by theory, the inventor notes that a plausible explanation for the results describe herein is that the exothermic, self-desiccating nature of the hydration processes associated with cement mortar 2 created an environment such that any of three latex polymers of diverse chemistry, a vinyl acetate/ethylene (VAE), an acrylic and a styrene-butadiene rubber (SBR), integrated to form a polymer film with sufficient strength to create substrate failure when cured below the freezing point of water.

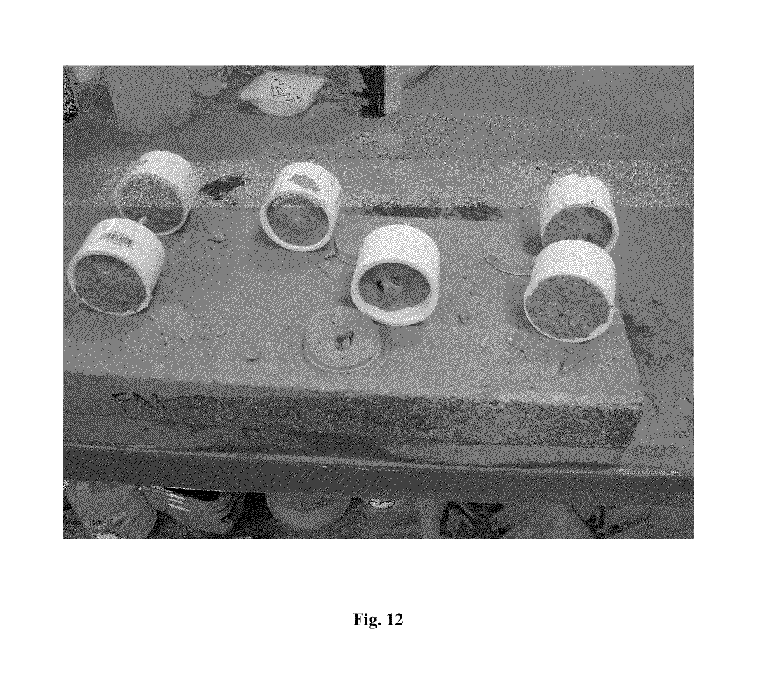

FIGS. 12-17 document adhesion performance of polymer modified cement mortar 2 cast over porous concrete substrate when cured above or below the freezing point of water.

FIG. 12 displays cement mortar 2 plus polymer 2 samples cured below the freezing point of water for 20 hours and then moved indoors at ambient laboratory temperature for approximately four hours before being tested. The average pull-off strength value was 3.19 MPa (463 psi). It is interesting to note three samples experienced failure within the mortar, CF/A, while three samples experienced failure within the substrate, CF/S. This suggests the direct tensile strength of cement mortar 2 plus polymer 2 cured below the freezing point of water for 20 hours and temperature-equilibrated for four hours is very close to 3.19 MPa (463 psi), as is the strength of the substrate material. This correlates well with the direct tensile strength information displayed in FIG. 10.

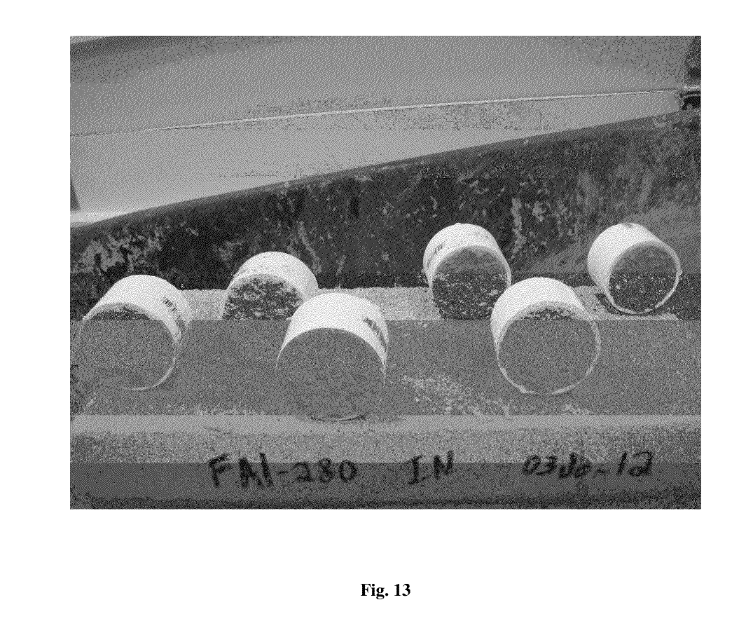

FIG. 13 displays cement mortar 2 plus polymer 2 samples cured above the freezing point of water for 24 hours before being tested. The average pull-off strength value was 2.79 MPa (405 psi). All samples experienced failure within the substrate, CF/S. The direct tensile strength of cement mortar 2 plus polymer 2 cured indoors for 24 hours was 2.97 MPa (431 psi), which was greater than the strength of the substrate material.

Polymer 2 is a vinyl acetate/ethylene (VAE) dispersible polymer powder (DPP) with T_{g}=−7° C. (19° F.) and MFT=0° C. (32° F.). According to a process such as is described herein, CSA cement based mortars containing VAE DPP may be useful in low temperature applications.

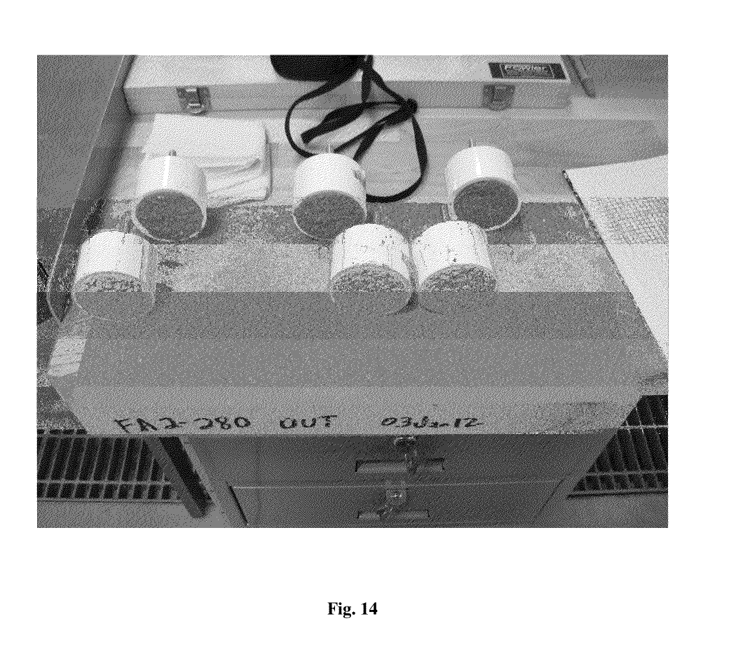

FIG. 14 displays cement mortar 2 plus polymer 3 samples cured below the freezing point of water for 20 hours and subsequently temperature-equilibrated at ambient laboratory temperature for four hours before being tested. The average pull-off strength value was 2.94 MPa (426 psi). All samples experienced failure within the substrate, CF/S. The direct tensile strength of cement mortar 2 plus polymer 3 cured outdoors below the freezing point of water for 20 hours and temperature-equilibrated indoors for four hours was greater than 3.04 MPa (441 psi). Given the failure mode, the bond strength between cement mortar 2 plus polymer 3 and the porous concrete substrate was also greater than 3.04 MPa (441 psi).

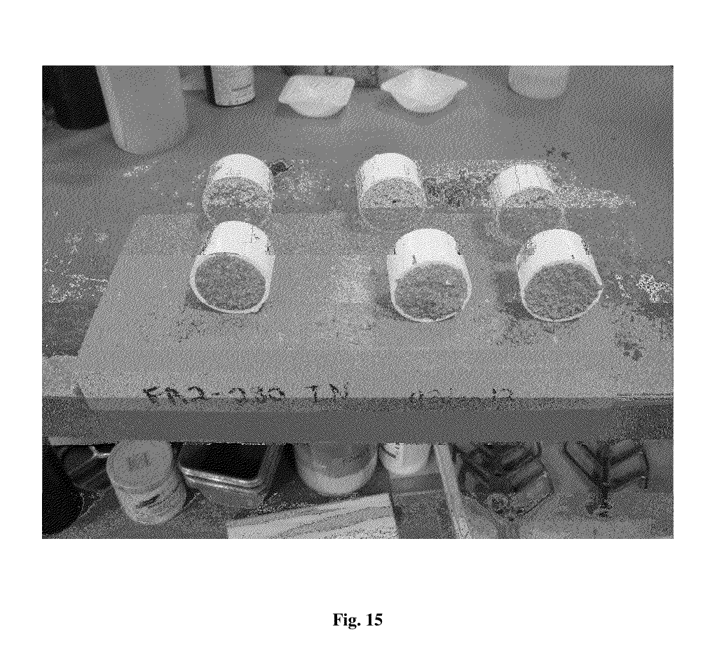

FIG. 15 displays cement mortar 2 plus polymer 3 samples cured above the freezing point of water for 24 hours before being tested. The average pull-off strength value was 3.47 MPa (503 psi). All samples experienced failure within the substrate, CF/S. The direct tensile strength of cement mortar 2 plus polymer 3 cured indoors above the freezing point of water for 24 hours was 3.04 MPa (441 psi). These results suggest both the direct tensile strength and bond strength were greater than substrate strength.

Polymer 3 is a poly-acrylic polymer powder with T_{g}=−10° C. (14° F.) and MFT=0° C. (32° F.). According to a process such as is described herein, CSA cement based mortars containing poly-acrylic polymer powders may be useful in low temperature applications.

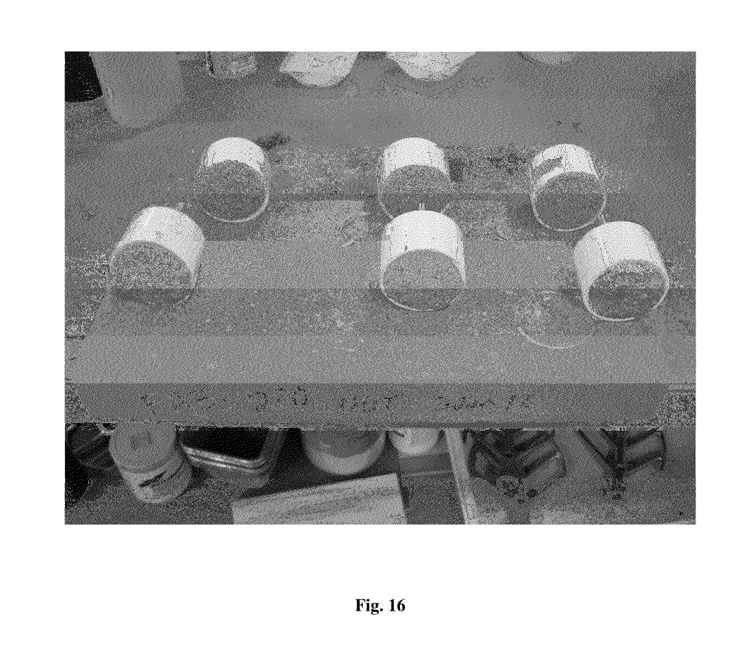

FIG. 16 displays cement mortar 2 plus polymer 4 samples cured below the freezing point of water for 20 hours and subsequently temperature-equilibrated at ambient laboratory temperature for four hours before being tested. The average pull-off strength value was 2.17 MPa (315 psi). All samples experienced failure within the substrate, CF/S. The direct tensile strength of cement mortar 2 plus polymer 4 cured outdoors below the freezing point of water for 20 hours and temperature-equilibrated indoors for four hours was greater than 2.17 MPa (315 psi), as was the bond strength between new mortar and existing porous concrete substrate.

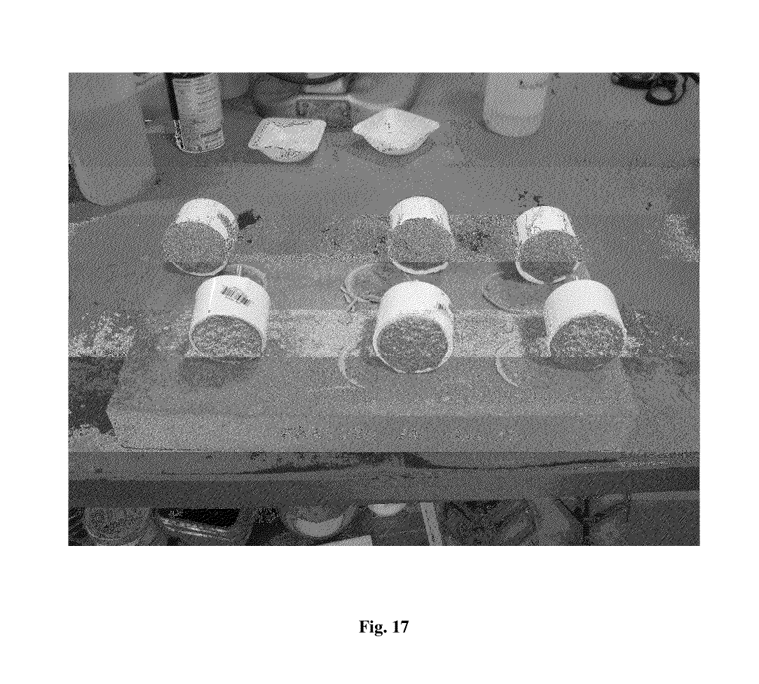

FIG. 17 displays cement mortar 2 plus polymer 4 samples cured above the freezing point of water for 24 hours before being tested. The average pull-off strength value was 1.92 MPa (279 psi). All samples experienced failure within the substrate, CF/S. The direct tensile strength of cement mortar 2 plus polymer 4 cured indoors above the freezing point of water for 24 hours was not readily available; however, the direct tensile strength was greater than 1.92 MPa (279 psi).

Polymer 4 is a styrene butadiene rubber (SBR) polymer powder with T_{g}=15° C. (59° F.) and MFT=8° C. (46° F.). Unlike the case for polymer 2 or polymer 3, the cold weather curing conditions describe above were significantly below both the T_{g} and the MFT for the SBR polymer powder. A material such as is described herein possesses favorable properties even where the material has been cured below a constituent polymer's MFT. In an embodiment of a material such as is described herein, CSA cement based mortars containing SBR polymers may be useful in low temperature applications.

It should be noted that if an acceptable degree of polymer film formation had not been achieved in the tests described above, the failure modes would reasonably be expected to have been AF/S rather than CF/S.

Polymeric materials are typically chosen for application based upon their respective glass transition temperature (T_{g}) and minimum film forming temperature (MFT). Complete polymer film formation is typically achieved through a three-stage process of water removal, particle movement for increased density and polymer particle interdiffusion into a coherent film. The art has taught that latex polymers should not be applied below their MFT. According to a process such as is described herein, a rapid setting cement mortar containing a blend of calcium sulfoaluminate (CSA) cement and ordinary portland cement (OPC) provides a suitable environment for polymer film formation when applied over porous substrate and cured at temperatures below both the freezing point of water and the polymer's MFT.

Another example provides an illustration of the favorable properties of a material such as is described herein cured either below the freezing point of water (−7° C.) or at ambient laboratory temperature (˜28° C.). In this example, mortar formulation was according to Table 4. Sample 1, Sample 2 and Sample 3 as described in Table 5 were cast from the same mortar batch. Ordinary, plastic Dixie cups (˜16 oz) were utilized as molds. Both Sample 1 and Sample 2 were cured in a freezer at −7° C. (20° F.). Sample 3 was cured at ambient laboratory temperature. Temperature probes from an Extech HD200 temperature logger were inserted into both Sample 1 and Sample 2 for temperature measurement while curing inside the freezer. Sample 3 temperature measurements were taken with a Cen Tech infrared thermometer, Harbor Freight item number 93984. Increases in temperature of both Sample 1 and Sample 2 during the first 30 minutes of hydration demonstrate that the materials were indeed capable of “setting” and “hardening” when cured below the polymer's minimum film forming temperature of 0° C.

TABLE 4
Mortar formulation for temperature profile
analysis during hydration at −7° C. (20° F.)

| Material | Mass (g) |
|---|---|
| CSA Cement | 400 |
| Ordinary Portland Cement | 100 |
| Anhydrite | 140 |
| Gypsum | 20 |
| VAE Dispersible Polymer Powder (Tg = −7° C., | 100 |
| MFF = 0° C.) | |
| Fine Sand | 600 |
| Coarse Sand | 900 |
| Lithium Carbonate | 1 |
| Tartaric Acid | 1 |
| Melflux 1641F (superplasticizer) | 6 |
| HEMC (MKX 15,000) | 1 |
| Agitan P803 (powdered de-foamer) | 2 |
| Water | 280 |

TABLE 5
Temperature measurements versus curing time for mortar displayed
in Table 4 cured both below the freezing point of water (−7°
C.) and at ambient laboratory temperature (~28° C.)

| Curing | Sample 1 Hydration | Sample 2 Hydration | Sample 3 Hydration |
|---|---|---|---|
| Time | Temperature (° C.) | Temperature (° C.) | Temperature (° C.) |
| (min) | (cured at −7° C.) | (cured at −7° C.) | (cured at ambient T) |
| 19 | 32 | 30 | 31 |
| 20 | 34 | 32 | 32 |
| 23 | 35 | 33 | 34 |
| 25 | 35 | 33 | 36 |
| 27 | 37 | 34 | 36 |
| 37 | 35 | 32 | 38 |
| 50 | 15 | 15 | 40 |
| 57 | 11 | 12 | 37 |
| 90 | 5 | 7 | 37 |
| 100 | 2 | 5 | 35 |
| 120 | 2 | 1 | 33 |
| 180 | −5 | −3 | 32 |

In yet another example, favorable compressive strength properties of a material according such as is described herein are demonstrated. Latex polymer modified cement mortar formulations shown in Table 6 were cured either below the freezing point of water (−7° C.) or at ambient laboratory temperature (˜28° C.). All temperature measurements were taken with a Cen Tech infrared thermometer, Harbor Freight item number 93984 (http://www.harborfreight.com/infrared-thermometer-93984.html). Compressive strength test results are shown in Table 7.

A material such as is described herein can be prepared by inter alia curing a mixture for 18 hrs below the freezing point of water and subsequently thawing at ambient temperature for 6 hours before testing. The temperature profile information displayed in Table 8 clearly illustrates commencement of hydration reactions for each sample with each temperature rise trend. In compressive strength testing, each tested sample's compressive strength was greater than 1000 psi. Each cylinder displayed similar failure modes, “well formed cone on one end, vertical cracks running through each cap”. Similar failure modes across all samples, both those cured below the freezing point of water and the sample cured at ambient laboratory conditions, suggest each mortar cylinder hydrated to form similar microstructures which resulted in similar compressive strength values with similar failure modes after curing for 24 hours.

TABLE 6
Mortar formulation for temperature profile
analysis during hydration at −7° C. (20° F.)

| Material | Mass (g) |
|---|---|
| CSA Cement | 400 |
| Ordinary Portland Cement | 100 |
| Anhydrite | 140 |
| Gypsum | 20 |
| VAE Dispersible Polymer Powder (Tg = −7° C., | 100 |
| MFF = 0° C.) | |
| Fine Sand | 600 |
| Coarse Sand | 900 |
| Silica Fume (Rheomac SF100) | 100 |
| Lithium Carbonate | 1 |
| Tartaric Acid | 1 |
| Melflux 1641F (superplasticizer) | 4 |
| HEMC (MKX 15,000) | 1 |
| Agitan P803 (powdered de-foamer) | 2 |
| Water | 280 |

TABLE 7
Temperature measurements versus curing time for mortar samples cast
in the form of 6″ × 12″ cylinders based upon the formulation
displayed in Table 7 cured either below the freezing point of water
20° F. (−7° C.) or at ambient laboratory temperature 82° F. (~28° C.)

| | Sample 1 | Sample 2 | Sample 3 | Sample 4 |
|---|---|---|---|---|
| | Hydration | Hydration | Hydration | Hydration |
| | Tempera- | Tempera- | Tempera- | Tempera- |
| Curing | ture (° F.) | ture (° F.) | ture (° F.) | ture (° F.) |
| Time | (cured at | (cured at | (cured at | (cured at |
| (min) | 20° F.) | 20° F.) | 20° F.) | 82° F.) |
| 5 | 75 | 92 | 83 | 77 |
| 10 | 90 | 94 | No reading | 92 |
| 30 | 98 | 104 | 93 | 109 |
| 35 | 103 | 106 | No reading | 112 |
| 45 | 101 | 104 | 98 | 113 |
| 50 | 95 | 101 | 98 | 115 |
| 70 | 85 | 98 | 94 | 115 |
| 85 | 83 | 87 | 86 | 116 |
| 95 | 76 | 82 | 85 | 115 |
| 125 | 71 | 78 | 81 | 114 |
| 145 | 69 | 72 | 79 | 114 |
| 160 | 64 | 69 | 75 | 112 |
| 170 | 62 | 66 | 75 | 110 |
| 180 | 59 | 66 | 75 | 105 |
| 185 | 55 | 65 | No reading | No reading |
| 195 | 55 | 61 | No reading | No reading |
| 225 | 57 | No reading | 75 | No reading |
| 240 | 51 | No reading | 69 | No reading |
| 250 | 49 | 57 | 63 | No reading |
| 300 | 37 | 47 | 52 | 94 |
| 310 | 36 | 45 | 49 | 91 |

TABLE 8
Compressive strength values for 6″ × 12″ cylinders otherwise known
as Sample 1, Sample 2, Sample 3 and Sample 4 displayed in Table 8

| Curing Period | Sample 1 | Sample 2 | Sample 3 | Sample 4 |
|---|---|---|---|---|
| 24 hours | 1700 psi | 1830 psi | 1790 psi | 2050 psi |

Every reference cited herein is incorporated fully by reference. To the extent that there be any conflict between the teaching of any reference and that of the instant specification, the teaching of the instant specification shall control.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A cured cementitious material made by steps comprising:
preparing a composition comprising, as ingredients, water, a hydraulic binding agent, a latex polymer, an accelerating admixture, a plasticizing admixture and optionally a retarding admixture or a rheology modifier or another ingredient, by placing the ingredients in proximity to one another, thereby forming a prepared composition;
mixing the prepared composition, thereby forming a mixed composition;
curing the mixed composition at a temperature below zero degrees Celsius for a first period of time, thereby forming a cured cementitious material;
wherein the cured cementitious material formed at the end of a first period of time of between about eighteen and twenty hours and thereafter permitted to equilibrate for a second period of time to an ambient temperature of from about twenty degrees Celsius to about thirty degrees Celsius possesses: (i) a compressive strength of at least about 1000 psi when tested according to ASTM C39 at the ambient temperature; (ii) a compressive strength of at least about 1000 psi when tested according to ASTM C109 at the ambient temperature; or (iii) a direct tensile strength of at least about 200 psi when tested according to ASTM C307 at the ambient temperature.

2. A cured cementitious material made by steps comprising:
preparing a composition comprising, as ingredients, water, a hydraulic binding agent, a latex polymer, an accelerating admixture, a plasticizing admixture and optionally a retarding admixture or a rheology modifier or another ingredient, by placing the ingredients in proximity to one another, thereby forming a prepared composition;
mixing the prepared composition, thereby forming a mixed composition;
curing the mixed composition at a temperature below the latex polymer's MFT for a first period of time, thereby forming a cured cementitious material;
wherein the cured cementitious material formed at the end of a first period of time of between about eighteen and about twenty hours and thereafter permitted to equilibrate for a second period of time to an ambient temperature of from about twenty degrees Celsius to about thirty degrees Celsius possesses: (i) a compressive strength of at least about 1000 psi when tested according to ASTM C39 at the ambient temperature; (ii) a compressive strength of at least about 1000 psi when tested according to ASTM C109 at the ambient temperature; or (iii) a direct tensile strength of at least about 200 psi when tested according to ASTM C307 at the ambient temperature.

3. An article comprising a cured cementitious substrate, wherein the substrate is subject to degradation or in need of amelioration, and a cured cementious material according to claim 1.

4. An article comprising a cured cementitious substrate, wherein the substrate is subject to degradation or in need of amelioration, and a cured cementious material according to claim 2.

5. A process for extending the useful life of a cured cementitious substrate, the process comprising contacting with the substrate an amount of a composition comprising water, a hydraulic binding agent, a latex polymer, an accelerating admixture, a plasticizing admixture and optionally a retarding admixture or a rheology modifier or another ingredient, and curing the composition in situ at a temperature below zero degrees Celsius or below the MFT of the latex polymer.

6. A process according to claim 5, wherein the substrate comprises a load-bearing surface.

7. A process according to claim 5, wherein the substrate comprises a non-load-bearing surface.

8. A cured cementitious material according to claim 1, wherein the hydraulic binding agent comprises calcium sulfoaluminate cement or calcium aluminate cement.

9. A cured cementitious material according to claim 2, wherein the hydraulic binding agent comprises calcium sulfoaluminate cement or calcium aluminate cement. 12.

10. A cured cementitious material according to claim 1, wherein the second period of time is from about four hours to about six hours.

11. A cured cementitious material according to claim 2, wherein the second period of time is from about four hours to about six hours.

12. An article according to claim 3, wherein the hydraulic binding agent comprises calcium sulfoaluminate cement or calcium aluminate cement.

13. An article according to claim 4, wherein the hydraulic binding agent comprises calcium sulfoaluminate cement or calcium aluminate cement.

14. A process according to claim 5, wherein the hydraulic binding agent comprises calcium sulfoaluminate cement or calcium aluminate cement.

15. A process according to claim 6, wherein the hydraulic binding agent comprises calcium sulfoaluminate cement or calcium aluminate cement.

16. A process according to claim 7, wherein the hydraulic binding agent comprises calcium sulfoaluminate cement or calcium aluminate cement.

17. A process according to claim 5, wherein the composition is cured in situ at a temperature below zero degrees Celsius.

18. A process according to claim 5, wherein the composition is cured in situ at a temperature below the MFT of the latex polymer.

19. A process according to claim 6, wherein the composition is cured in situ at a temperature below zero degrees Celsius.

20. A process according to claim 7, wherein the composition is cured in situ at a temperature below the MFT of the latex polymer.
